(19) United States
(12) Patent Application Publication
(10) Pub. No.: US 2008/0046168 A1
(43) Pub. Date: Feb. 21, 2008

(54) SYSTEM AND METHOD FOR DETERMINING AN AIRCRAFT CENTER OF GRAVITY

(76) Inventors: Dennis K. McCarthy, Higley, AZ (US); Aaron L. Harris, Mesa, AZ (US); Jon M. Goettings, Mesa, AZ (US)

Correspondence Address: WEISS & MOY PC, 4204 NORTH BROWN AVENUE, SCOTTSDALE, AZ, 85251, US

(21) Appl. No.: 11/458,174

(22) Filed: Jul. 18, 2006

(51) Int. Cl. G06F 17/10

(52) U.S. Cl. 701/124

(57) ABSTRACT

A system and method of calculating a center of gravity of an aircraft positions an aircraft on an aircraft scale. Weight readings are recorded at each wheel of the aircraft. A photograph of the aircraft on the aircraft scale is taken. The photograph is downloaded to a computer. Relative position readings between identifiable points on the photograph of the aircraft are taken. The relative position readings are transformed into an aircraft coordinates system. The weight readings taken at each wheel of the aircraft are then entered and the longitudinal center of gravity of the aircraft is calculated.

### BACKGROUND OF THE INVENTION

1. Field of the Invention

The present invention relates generally to aircraft, and more particularly, to a system and method for determining a center of gravity of an aircraft.

2. Background Information

In an aircraft, especially a helicopter, the pilot must not only consider the gross weight of the aircraft, but must also determine that the load is arranged to fall within the allowable center-of-gravity range specified in the aircraft weight and balance limitations. The center of gravity is the point where the aircraft is in balance, the point at which all the weight of the system is considered to be concentrated. The allowable range in which the center of gravity may fall is referred to as the center of gravity range. The exact location and length of this range is specified for each aircraft.

In an aircraft, especially a helicopter, the ideal condition is to have the aircraft in such perfect balance that the fuselage will remain horizontal in level flight, with no cyclic pitch control necessary except that which may be made necessary by wind conditions. Out of balance loading of the aircraft makes control more difficult and decreases maneuverability.

Thus, knowing the longitudinal center of gravity is critical to aircraft safety, performance, and longevity. It has therefore, been required to determine aircraft center of gravity for each unique deployment configuration.

Aircraft weighing is a difficult and imprecise activity, particularly in austere field environments. Currently, it requires Peculiar Ground Support Equipment (PGSE) and requires jacking and maneuvering the aircraft to achieve desired attitude. It requires establishing aircraft orientation and location using plumb-bobs from identifiable aircraft points to points on the ground which are typically marked using chalk lines. Measurements are taken from chalk line to chalk line using a tape measure to establish scale locations. Aircraft attitude is established with a plumb-bob and a PGSE inclinometer. Each of the above steps is somewhat laborious and is subject to error. For example, an error of +/−˜0.1 inch on each chalk line and tape measurement may be made.

Therefore, it would be desirable to provide a system and method to determine a center of gravity of an aircraft that overcomes the problems associated with the prior art. The system and method will be able to determine a center of gravity of an aircraft less laboriously and more accurately than the prior art.

### SUMMARY OF THE INVENTION

A system and method of calculating a center of gravity of an aircraft positions an aircraft on an aircraft scale. Weight readings are recorded at each wheel of the aircraft. A photograph of the aircraft on the aircraft scale is taken. The photograph is downloaded to a computer. Relative position readings between identifiable points on the photograph of the aircraft are taken. The relative position readings are transformed into an aircraft coordinates system. The weight readings taken at each wheel of the aircraft are then entered and the longitudinal center of gravity of the aircraft is calculated.

A computer system comprising a processor for executing program instructions and a memory coupled to the processor for storing the program instructions, the programming instructions comprising: downloading a photograph of an aircraft on an aircraft scale; recording relative position readings on landing gear wheels of the aircraft in the photograph; recording relative position readings on orientation points on the aircraft in the photograph; transforming the relative position readings into an aircraft coordinates system; entering weight readings taken at each wheel of the aircraft; and calculate the longitudinal center of gravity of the aircraft.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a is a simplified block diagram of a system for aircraft center of gravity using digital imagery;

FIG. 2 is a photograph of an aircraft on an aircraft scale;

FIG. 3 is a screen view taken from the computer program of the present invention;

FIG. 4 is a magnified view of the photograph showing the front landing gear of the aircraft;

FIG. 5 is a magnified view of the photograph showing the tail landing gear of the aircraft;

FIG. 6A is a photograph of the aircraft with spatially identifying features;

FIG. 6B is a photograph of the aircraft with identifiable points shown;

FIG. 6C is a photograph of the aircraft with weight scale locations; and

FIG. 6D is a photograph of the aircraft with vertical weight vectors defined at weight scales locations.

### DETAILED DESCRIPTION OF THE PREFERRED EMBODIMENTS

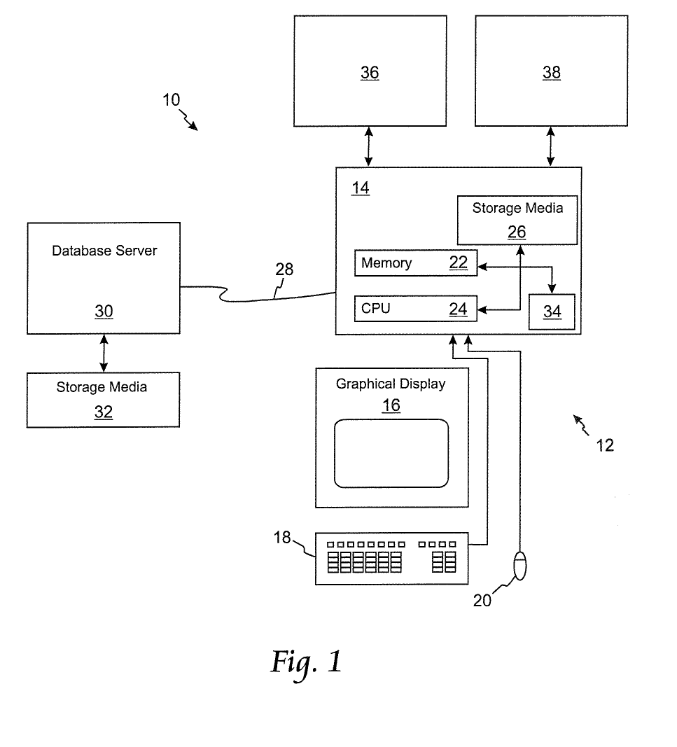

Referring to FIG. 1, a system 10 for determining a center of gravity of an aircraft is shown. The system 10 generally uses a main computer system 12. The computer system 12 will have a processor unit 14 and a display 16. Input devices are coupled to the processor unit 14. The input devices may be a keyboard 18, a mouse 20 and the like. The processor unit 14 will further have an I/O port 34 for downloading data to the processor unit 14. The I/O port 34 may be a USB port, a FireWire port or the like. The listing of the above is given as an example and should not be seen as to limit the scope of the present invention. Alternatively, the processor unit 14 may have a reading device 36 coupled to the processor unit 14. The reading device 36 may be a memory card reader or the like. The processor unit 14 may further have a scanning device 38 coupled thereto. The scanning device 38 could also be used to download data to the processor unit.

Through the execution of program instructions forming a computer program product within the computer system 12, the computer system 12 will provide a means for determining a center of gravity of an aircraft. The program instructions may be located within a memory 22 of the processor unit 14 and executed by a central processing unit 24 (CPU). Any data generated from the running of the program instructions such as a center of gravity of an aircraft and the like may be stored entirely within a storage media 26 and/or the memory 22.

Alternatively, the computer system 12 may have a connection 28 to a network such as a local-area network (LAN), wide-area network (WAN) or the Internet. The connection 28 may be a wired connection, a wireless connection, or the like. In a network implementation, the program instructions may be located within a database server 30. Any data stored such as the center of gravity of an aircraft and the like may be stored in a storage media 32 coupled to the database server 30.

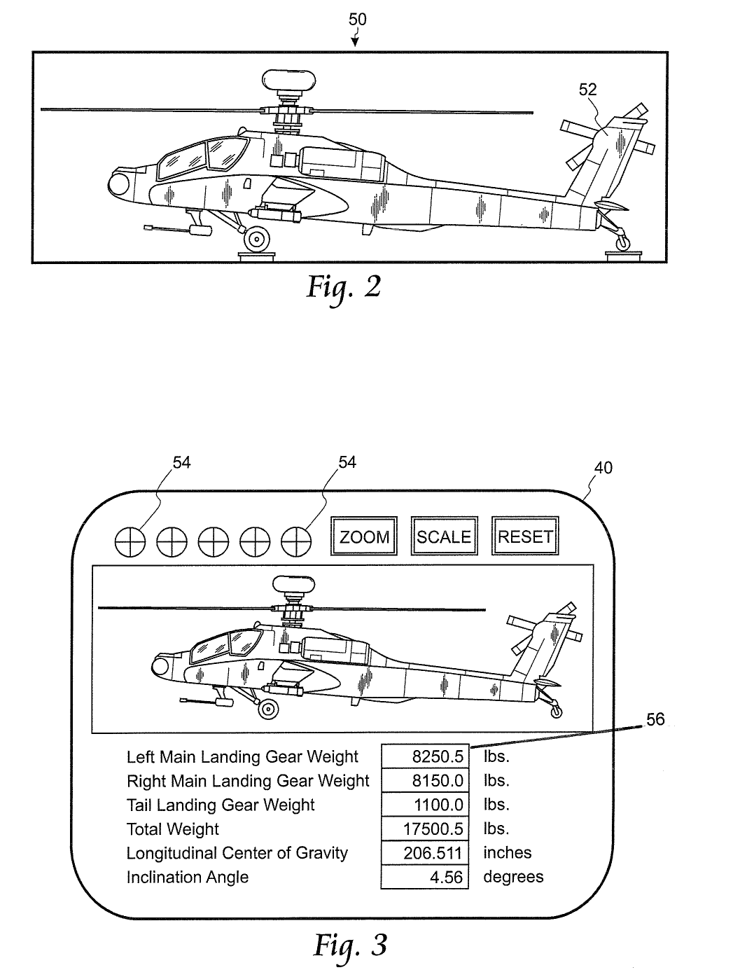

Referring to FIG. 2, in order to determine the center of gravity of the aircraft, the aircraft is placed on standard aircraft scale(s). In general, the aircraft is moved so that each wheel of the aircraft is placed on a platform scale. A weight reading is then taken at each wheel of the aircraft. As shown in FIG. 2, a photograph 50 of the aircraft 52 is taken. The photograph 50 is generally a digital photograph and is taken while the aircraft 52 is positioned on the aircraft scales.

The photograph 50 is loaded onto the computer system 12 and/or the database server 30. The photograph 50 is generally loaded onto the computer system 12 and/or the database server 30 via the I/O port 34, the reading device 36, or the scanning device 38. However, the photograph 50 may be loaded onto the computer system 12 and/or the database server 30 in other manners without departing from the spirit and scope of the present invention.

Referring now to FIG. 3, a screen view 40 taken from the computer program is shown. As may be seen from FIG. 3, the photograph 50 has been uploaded to the computer system 12 and opened in the computer program. The user will then drag and scale corresponding icons 54 on each landing gear wheel.

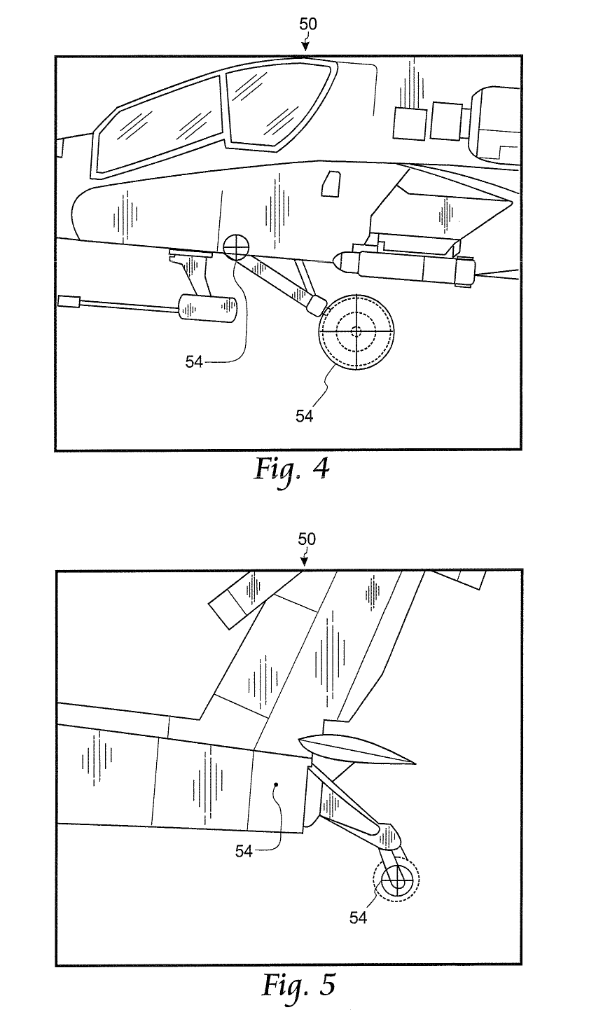

As shown in FIGS. 4 and 5, for accuracy, the user may zoom in to a specific area of the photograph 50. The user will drag a corresponding icon 54 for the right main landing gear to the desired point. The user can scale the icon 54 to the entire tire and wheel assembly, to the hub of the wheel, or to the axle. The user will do the same for corresponding icons 54 for the left main landing gear and the tail landing gear. The icons 54 will allow one to measure the distances between the front left and right landing gear and the distance between the front landing gear and the rear landing gear.

In the program, the user will select two additional orientation points. The orientation points are selected from a menu of choices of observable, identifiable objects. The orientation points are precise known locations on the structure of the aircraft 52. When an identifiable mark has been selected, an icon 54 is then dragged and scaled on the identifiable mark. The icons 54 have same shape as the target structure and are scalable for easy location. Only two are required for orientation. If more than two are selected a mathematical best fit operation is performed.

Referring back to FIG. 3, once icons 54 have been placed on the identifiable marks and measurements taken, the user will enter the weight readings taken at each wheel of the aircraft. These readings will be entered in the appropriate box 56 shown on the screen view 40. First, the computer program will approximate the vertical center of gravity from the operators manual based on gross weight. The computer program will then calculate the longitudinal center of gravity. The subject software will use used vector math to correct for aircraft orientation, landing gear stroke, ground attitude, and parallax to transform the scale readings into the aircraft coordinates system to determine the longitudinal center of gravity location. Scale information at two aircraft attitudes can be used to determine vertical center of gravity location.

In order to transform the scale readings into the aircraft coordinates system, transformation matrices are used. The transformation matrix will define how to map points from one coordinate system into another coordinate system. By modifying the contents of a transformation matrix, you can perform several standard graphical display operations, including translation, rotation, and scaling.

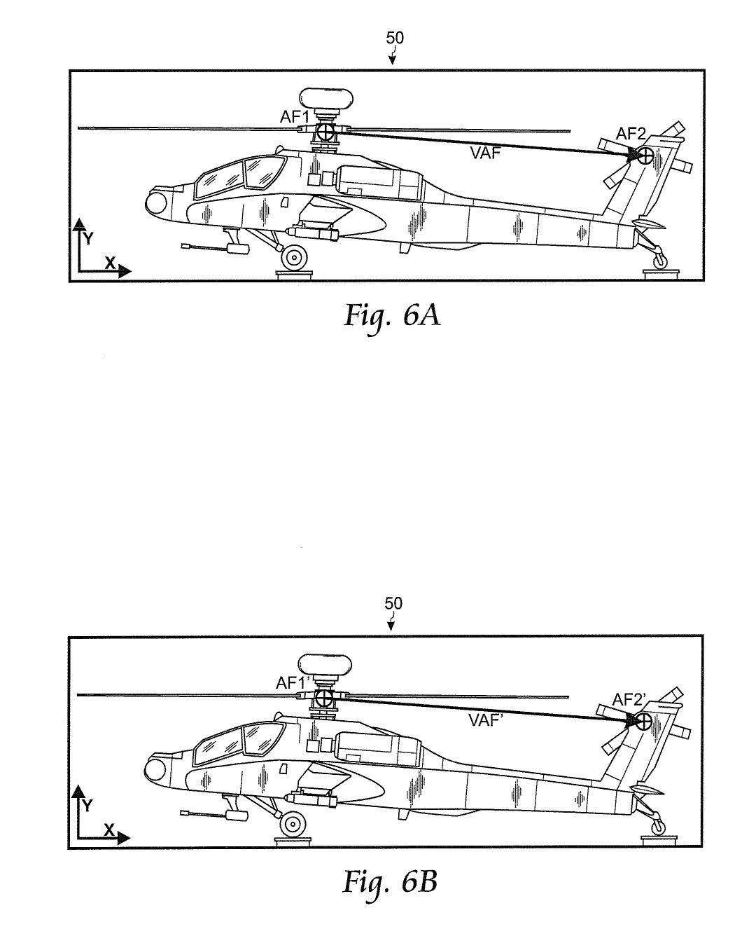

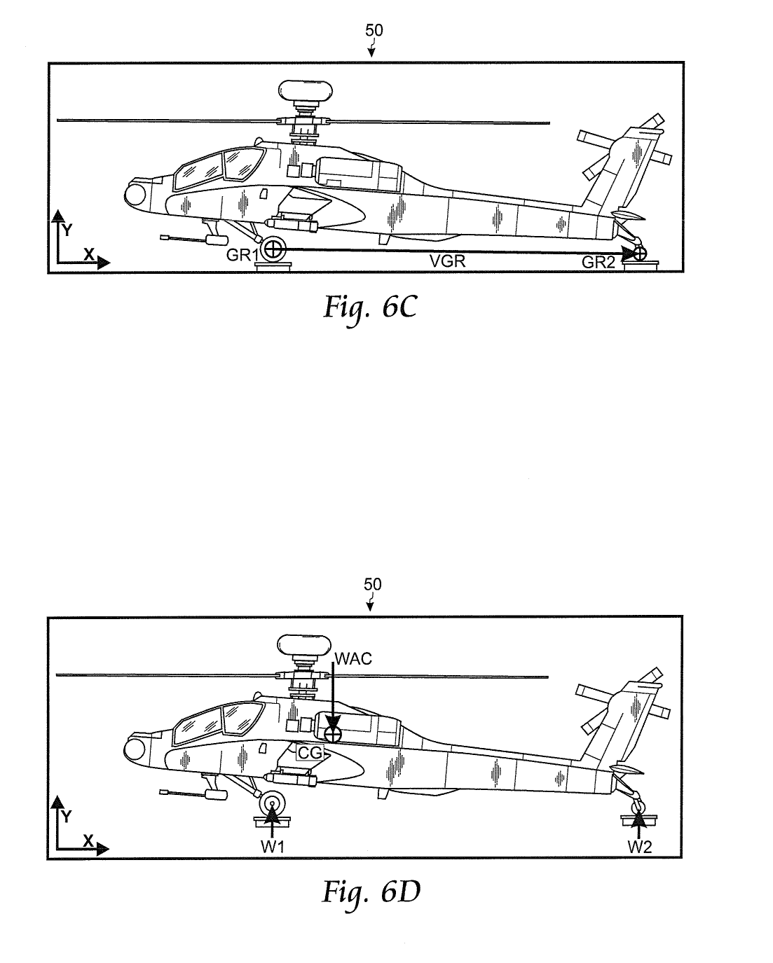

Referring to FIG. 6A, two points are defined on the airframe at known locations (AF1 and AF2). These points are in the photograph coordinate system (pixel count) identified as X and Y.

### Vector (VAF) is defined from these points.

$$VAF = \{ \begin{matrix}{VAF}_{x} = AF {2}_{x} - AF {1}_{x} \\ {VAF}_{y} = AF {2}_{y} - AF {1}_{y}\end{matrix} \}$$

### The length of this vector is

|VAF|=(VAF_{X})²+(VAF_{X})²

Referring to FIG. 6B, two points are pre-defined at the airframe at known aircraft locations (AF1′ and AF2′. These points are in the aircraft coordinate system identified as X′ and Y′. They are specific to a particular aircraft and are defined prior to tool deployment.

### Vector (VAF′) is defined from these points.

$${VAF}^{′} = \{ \begin{matrix}{{VAF}^{′}}_{x} = AF {{2}^{′}}_{x} - AF {{1}^{′}}_{x} \\ {{VAF}^{′}}_{y} = AF {{2}^{′}}_{y} - AF {{1}^{′}}_{y}\end{matrix} \}$$

### The length of this vector is

|VAF′|=(VAF′_{X})²+(VAF′_{X})²

### A scale factor (S) is defined between the aircraft coordinate system and photograph coordinate system.

$$S = \frac{\vert {VAF}^{′} \vert}{\vert VAF \vert}$$

A rotation angle (α) is defined between the aircraft coordinate system and the photograph coordinate system. The sine and cosine of this angle are

$$Sin ( α ) = \frac{( {VAF}_{x} ) ( {{VAF}^{′}}_{y} ) - ( {VAF}_{Y} ) ( {{VAF}^{′}}_{X} )}{( \vert VAF \vert ) ( \vert {VAF}^{′} \vert )}$$

$$Cos ( α ) = \frac{( {VAF}_{X} ) ( {{VAF}^{′}}_{X} ) + ( {VAF}_{Y} ) ( {{VAF}^{′}}_{Y} )}{( \vert VAF \vert ) ( \vert {VAF}^{′} \vert )}$$

### A transformation matrix [A] can now be defined between the aircraft coordinate system and the photograph coordinate system.

$$[ A ] = ( \begin{matrix}Cos ( α ) & - Sin ( α ) \\ Sin ( α ) & Cos ( α )\end{matrix} )$$

With the transformation matrix [A] and scale factor (S) defined. The first airframe point in photograph coordinates (AF1) can now be specified in aircraft coordinates (AF1″)

AF1″=S*[A]{AF1}

### An offset vector {O} is the difference between the origins of the photograph coordinate system and the aircraft coordinate system expressed in the aircraft coordinate system.

$$\{ O \} = \{ \begin{matrix}AF {{1}^{″}}_{X} - AF {1}_{X} \\ AF {{1}^{″}}_{Y} - AF {1}_{Y}\end{matrix} \}$$

Referring to FIG. 6C, two points are defined at the weighing scales location (GR1 and GR2). These points are in the photograph coordinate system (pixel count) identified as X and Y.

### Vector {VGR} is defined from these points.

$$VGR = \{ \begin{matrix}VGR = GR {2}_{x} - GR {1}_{x} \\ {VGR}_{y} = GR {2}_{y} - GR {1}_{y}\end{matrix} \}$$

### The length of this vector is

|VGR|=(VGR_{X})²+(VGR_{X})²

A rotation angle (β) is defined between the earth gravitational coordinate system and the photograph coordinate system. The sine and cosine of this angle are

$$Sin ( β ) = \frac{( {VAF}_{x} ) ( {VGR}_{y} ) - ( {VAF}_{Y} ) ( {VGR}_{X} )}{( \vert VAF \vert ) ( \vert VGR \vert )}$$

$$Cos ( β ) = \frac{( {VAF}_{X} ) ( {VGR}_{X} ) + ( {VAF}_{Y} ) ( {VGR}_{Y} )}{( \vert VAF \vert ) ( \vert VGR \vert )}$$

### A transformation matrix [B] can now be defined between the aircraft coordinate system and the photograph coordinate system.

$$[ B ] = ( \begin{matrix}Cos ( β ) & - Sin ( β ) \\ Sin ( β ) & Cos ( β )\end{matrix} )$$

### The weight scale locations are expressed in the aircraft coordinate system via

{GR1′}=S*[A]{GR1}−{O}

{GR2′}=S*[A]{GR2}−{O}

### Referring to FIG. 6D, vertical weight vectors are defined at weight scales locations.

### These vectors are transformed into photograph coordinate system and then aircraft coordinate system using

{W1′}=[A][B]{W1}

{W2′}=[A][B]{W2}

### The total weight of the aircraft is

{WAC′}={W1′}+{W2′}

For the current application the vertical center of gravity (CG_{Y}) of the aircraft must be known. Summation of moment about the aircraft origin results in

$$\begin{matrix}\sum M = 0 \\ = \{ GR {1}^{′} \} X \{ W {1}^{′} \} + \{ GR {2}^{′} \} X \{ W {2}^{′} \} + \{ {CG}^{′} \} X \{ {WAC}^{′} \}\end{matrix}$$

### Where the cross product X is defined as

V_{Z}=(V1_{X})(V2_{Y})−(V1_{Y})(V2_{X})

### Solving for the aircraft longitudinal center of gravity (CG′_{X}) results in

$${{CG}^{′}}_{X} = \frac{( {CG}_{Y} ) ( {WAC}_{X} ) - \{ GR {1}^{′} \} X \{ W {1}^{′} \} - \{ GR {2}^{′} \} X \{ W {2}^{′} \}}{{WAC}_{Y}}$$

Using the above, the subject software will calculate and display the total weight, longitudinal center of gravity, and aircraft inclination angle in the appropriate box 56 on the screen view 40 of FIG. 3.

The process may be repeated using an image of the front of the aircraft to determine the lateral center of gravity.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A computer system comprising a processor for executing program instructions and a memory coupled to the processor for storing the program instructions, the programming instructions comprising:
downloading a photograph of an aircraft positioned on an aircraft scale;
recording relative position information reading between identifiable points on the aircraft in the photograph;
entering weight readings taken at each wheel of the aircraft; and
calculate the longitudinal center of gravity of the aircraft.

2. The computer program of claim 1 further comprising transforming the relative position information readings into an aircraft coordinates system.

3. The computer program of claim 1 wherein taking relative position readings comprises:
drag and scale a first set of icons on landing gear wheels of the aircraft in the photograph; and
drag and scale a second set of icons on orientation points on the aircraft in the photograph.

4. The computer program of claim 3 wherein drag and scale a first set of icons on landing gear wheels comprises:
drag and scale a first icon on a front right side landing gear wheel;
drag and scale a second icon on a front left side landing gear wheel; and
drag and scale a third icon on a rear landing gear wheel.

5. The computer program of claim 3 wherein drag and scale a first set of icons on landing gear wheels comprises drag and scale a first set of icons on one of: the entire tire and wheel assemblies, on the hub of the wheels, or on axles of the wheels.

6. The computer program of claim 3 wherein drag and scale a second set of icons on orientation points on the aircraft further comprises selecting at least two orientation points on the aircraft.

7. The computer program of claim 6 wherein selecting at least two orientation points from a pull down menu further comprises performing a mathematical best fit operation if more than two orientation points are selected.

8. A computer system comprising a processor for executing program instructions and a memory coupled to the processor for storing the program instructions, the programming instructions comprising:
downloading a photograph of an aircraft on an aircraft scale;
recording relative position readings on landing gear wheels of the aircraft in the photograph;
recording relative position readings on orientation points on the aircraft in the photograph;
transforming the relative position readings into an aircraft coordinates system;
entering weight readings taken at each wheel of the aircraft; and
calculate the longitudinal center of gravity of the aircraft.

9. The computer program of claim 8 wherein recording relative position readings on the landing gear wheels comprises:
magnifying the photograph on the landing gear wheels; and
drag and scale a first set of icons on the landing gear wheels.

10. The computer program of claim 8 wherein recording relative position readings on orientation points on the aircraft comprises:
selecting at least two orientation points on the aircraft;
magnifying the photograph on the at least two orientation points; and
drag and scale a second set of icons on the at lest two orientation points on the aircraft.

11. The computer program of claim 9 wherein drag and scale a first set of icons on landing gear wheels comprises:
drag and scale a first icon on a front right side landing gear wheel;
drag and scale a second icon on a front left side landing gear wheel; and
drag and scale a third icon on a rear landing gear wheel.

12. The computer program of claim 9 wherein drag and scale a first set of icons on landing gear wheels comprises drag and scale a first set of icons on one of: the entire tire and wheel assemblies, on the hub of the wheels, or on axles of the wheels.

13. The computer program of claim 10 wherein selecting at least two orientation points further comprises performing a mathematical best fit operation if more than two orientation points are selected.

14. A method of calculating a center of gravity of an aircraft comprising:
positioning an aircraft on an aircraft scale;
recording weight readings at each wheel of the aircraft;
photographing the aircraft of the aircraft scale;
downloading the photograph of the aircraft to a computer;
taking relative position readings between identifiable points on the photograph of the aircraft;
transforming the relative position readings into an aircraft coordinates system;
entering weight readings taken at each wheel of the aircraft; and
calculate the longitudinal center of gravity of the aircraft.

15. The method of claim 14 wherein taking relative position readings comprises:
drag and scale a first set of icons on landing gear wheels; and
drag and scale a second set of icons on orientation points on the aircraft.

16. The method of claim 15 wherein drag and scale a first set of icons on landing gear wheels comprises:
drag and scale a first icon on a front right side landing gear wheel;
drag and scale a second icon on a front left side landing gear wheel; and
drag and scale a third icon on a rear landing gear wheel.

17. The method of claim 15 wherein drag and scale a first set of icons on landing gear wheels comprises drag and scale a first set of icons on one of: the entire tire and wheel assemblies, on the hub of the wheels, or on axles of the wheels.

18. The method of claim 15 wherein drag and scale a second set of icons on orientation points on the aircraft further comprises selecting at least two orientation points on the aircraft.

19. The method of claim 18 wherein selecting at least two orientation points further comprises performing a mathematical best fit operation if more than two orientation points are selected.

20. The method of claim 14 wherein transforming the scale readings into an aircraft coordinates system comprises using a transformation matrix map the scale readings into the aircraft coordinates system.
